(19) United States
(12) Patent Application Publication
(10) Pub. No.: US 2006/0264350 A1
(43) Pub. Date: Nov. 23, 2006

(54) Printing blanket cleaning material

(75) Inventor: Jon A. Howey, Simpsonville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BBA Nonwovens Simpsonville Inc.

(21) Appl. No.: 11/391,720

(22) Filed: Mar. 28, 2006

Related U.S. Application Data
(63) Continuation-in-part of application No. 10/839,739, filed on May 5, 2004, now Pat. No. 7,037,882.
(63) Continuation-in-part of application No. 10/839,741, filed on May 5, 2004.

(51) Int. Cl. C11D 17/00

(52) U.S. Cl. 510/295

(57) ABSTRACT

The invention is a cleaning material for cleaning printing machines. The cleaning material is comprised of a fabric that has been impregnated with a cleaning composition having a VOC content that is between 5 and 30 weight percent. In one embodiment, the cleaning composition comprises branched chain monobasic and/or dibasic esters that contain 2-ethyl hexanoate. The cleaning composition can also include additional low volatility solvents and surfactants. A particularly useful cleaning composition is comprised of isobutyl stearate in combination with branched chain monobasic and/or dibasic esters that contain 2-ethyl hexanoate. The cleaning material can be wound onto a roll that can be adaptable to fit commercially available printing machine cleaning devices.

### CROSS REFERENCE TO RELATED APPLICATIONS

This application is a continuation-in-part of U.S. patent application Ser. Nos. 10/839,739 and 10/839,741 both of which were filed May 5, 2004 and are incorporated herein by reference in their entirety.

### BACKGROUND OF THE INVENTION

The invention relates generally to a cleaning material that can be used to clean a printing machine, and more particularly to a cleaning material in the form of a nonwoven fabric impregnated with a cleaning composition.

One of the more common printing techniques is offset lithography printing. In offset printing, an ink roll transfers ink to a plate cylinder. The plate cylinder typically contains lithographic plates that are wrapped around the circumference of the cylinder. After the lithographic plates contact the ink roller, the plate cylinder then transfers the inked impression onto a blanket cylinder. The blanket cylinder is typically made of a soft material such as rubber. The blanket cylinder transfers the inked impression to a printable surface such as a continuous web of paper. In a blanket-to-blanket press, the paper web is fed between two blanket cylinders so that both sides of the paper are printed at once.

During the printing process, ink, dirt, and other residues may accumulate on the blanket cylinders. The accumulation of such residues can cause various problems, such as poor print image quality and damage to the blanket. Additionally, the blanket cylinder should be cleaned when the plates on the plate cylinder are changed. Traditionally, when a printing press needed cleaning, the press would be taken off-line and the equipment would be hand cleaned with solvents and rags. Hand cleaning the printing press has several disadvantages. Hand cleaning can be labor intensive and there is a loss of productivity due to the necessity of having the printing press off-line for cleaning. Solvents typically used for on-press cleanup in lithographic printing include mineral spirits, methyl ethyl ketone, toluene, xylene, glycol ethers, terpenes, heptane and hexane. These solvents are classified as VOCs (volatile organic compounds) and are subject to increasingly stringent governmental restrictions regulating the release of VOCs into the atmosphere and the disposal of solvent-containing used cleaning rags.

Several automated blanket cleaning systems have been developed to improve printing press cleaning and to lessen the amount of labor and printing press downtime. Typically, these systems involve the use of a cleaning fabric that is drawn across the surface of the rollers and cylinders. The cleaning fabric is provided in the form of a roll of fabric that has been impregnated with a solvent. The cleaning fabric is unrolled from the supply roll, moved across the surface of the blanket cylinder and then the used cleaning fabric is rolled onto a separate uptake roll for later disposal. Typically, the cleaning fabric is made from a spunlaced nonwoven that contains short wood pulp fibers about ¼ inch long and polyester staple fibers about 1.5 inch in length. The fibers are bonded together by hydroentanglement.

One of the selling points of automated blanket cleaning systems is that they lower solvent usage and reduce VOC emissions. Some blanket cleaning systems even promote that they provide virtually VOC-free cleaning. Typically, the currently available automated blanket cleaning systems have used specially formulated solvents of low volatility in order to limit VOC emissions. U.S. Pat. No. 5,386,157, for example, describes an automated blanket cleaning system employing a roll of cleaning fabric that is impregnated with a low volatility organic solvent that does not readily evaporate while the roll of cleaning fabric is mounted on the printing press.

In practice, however, it has been found that automated blanket cleaning systems that use low volatility solvents do not always clean the blanket cylinder adequately. As a result, it becomes necessary for the printing press operators to supplement the automated blanket cleaning system by manually cleaning the blanket with a rag and solvent. This typically involves using a relatively high VOC cleaning composition. Such hand cleaning increases the downtime for the printing press and involves additional labor costs. Also, by supplementing the automated cleaning system with manual cleaning in this manner, the overall amount of VOC released to the atmosphere is increased.

### BRIEF SUMMARY OF THE INVENTION

The present invention is based upon the recognition that an overall reduction in the release of VOCs during the operation of an automatic blanket cleaner can be realized by increasing rather than lowering the VOC content of the solvent used in the roll of cleaning fabric. Unlike existing automated blanket cleaning systems where the VOC content of the solvent used in the cleaning fabric is kept as low as possible, according to the present invention the cleaning composition has a VOC content above 5 percent, and preferably between about 5 and 30 weight percent. Having a VOC content above about 5 weight percent permits the cleaning material to more effectively clean printing press equipment and to avoid the necessity of hand washing the blanket. As a result and contrary to expectations, the overall amount of VOCs released is actually reduced in comparison to cleaning cloths having a low VOC content.

Typically, a fabric is impregnated with the cleaning composition to produce a cleaning material that is adeptly suited for cleaning printing press blankets. Cleaning compositions that are useful in the invention are typically comprised of an organic solvent having a VOC content that is between about 5 to 30 percent by weight, based on the total weight of the cleaning composition. In one embodiment, the cleaning composition comprises an organic solvent and a surfactant. Esters are a particularly suitable class of organic solvents because they are biodegradable and many exhibit a low vapor pressure. In one embodiment, the cleaning composition may include branched chain monobasic and dibasic esters that contain 2-ethyl hexanoate. Monobasic and dibasic esters containing 2-ethyl hexanoate are adeptly suited for cleaning printing presses because they have excellent cleaning properties for removing ink and other residues from the cylinders and do not adversely affect the surface of the polymeric blanket. In other embodiments, the cleaning composition may comprise a blend of esters including vegetable esters.

The cleaning composition can also include additional solvents and surfactants provided that the VOC content is not greater than about 30 weight percent. A particularly useful cleaning composition is comprised of isobutyl stearate in combination with branched chain monobasic and dibasic esters that contain 2-ethyl hexanoate.

The cleaning composition can be used with a cleaning cloth that is typically comprised of a fabric material. The fabric is typically impregnated with the cleaning composition, or is soaked in the cleaning composition before application to the blanket. The impregnated cleaning material can also be tightly wound onto a roll that can be used with commercially available cleaning devices.

The cleaning composition can be used with a variety of fabrics. Typically, the fabric is a nonwoven that has good strength and abrasion resistance. A spunbond nonwoven fabric is a particularly useful cleaning cloth. Typically, the spunbonded fabric comprises a web of substantially continuous filaments thermally point bonded together to provide a fabric with excellent strength and abrasion resistance while being able to carry and release adequate amounts of a cleaning solvent. The spunbonded nonwoven fabric has a relatively low loft or volume, making it adeptly suited for being tightly wound on a roll without the need for post calendering.

Thus, the invention provides an improved printing machine cleaning material having high strength and abrasion resistance that is impregnated with an exceptionally effective cleaning composition that does not deteriorate the surface of the printing blanket.

### BRIEF DESCRIPTION OF THE SEVERAL VIEWS OF THE DRAWING(S)

Having thus described the invention in general terms, reference will now be made to the accompanying drawing, which is not necessarily drawn to scale, and wherein:

FIG. 1 illustrates a cleaning material that is wound onto a roll around a central core.

### DETAILED DESCRIPTION OF THE INVENTION

The present invention now will be described more fully hereinafter with reference to the accompanying drawing, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

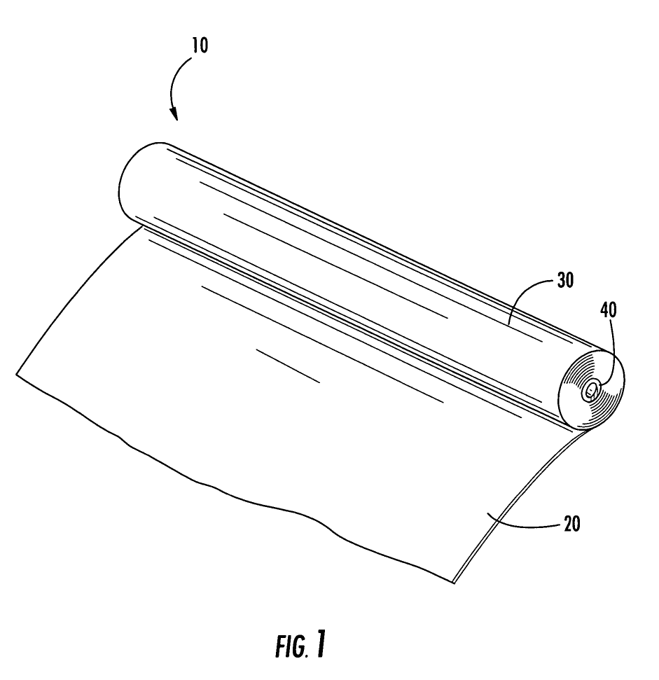

In one embodiment, the cleaning material is comprised of a fabric that is impregnated with a cleaning composition comprising an organic solvent that contains from about 5 to 30 weight percent VOC. With reference to FIG. 1, reference number 10 broadly designates a roll of cleaning material that is in accordance with the invention. As depicted in FIG. 1, the cleaning material 20 is wound around a central core 40 to form a roll of cleaning material.

The size, shape, and configuration of the roll 10 and core 40 can be adjusted so that the roll of cleaning material 10 can be used interchangeably with commercially available printing press cleaning devices. The cleaning material can be integrated into an automatic blanket cleaning system so that at a desired time the cleaning material is applied to the blanket with even pressure. Cleaning is accomplished by friction between the cleaning material and the blanket, and the dissolution of inks on the blanket. The used portion of the cleaning material can be reeled onto a take-up shaft or similar device.

The cleaning cloth is impregnated with a cleaning composition that contains one or more volatile organic compounds (VOC). The VOC level of the cleaning composition is typically from about 5 to 30 weight percent. In the context of the invention, VOC refers to the amount of volatile organic compound(s) present in the cleaning composition. VOC content is measured according to EPA Test Method 24, the contents of which are hereby incorporated by reference. In some embodiments, the cleaning composition may comprise a combination of high VOC solvent(s) and low VOC solvent(s) that do not readily evaporate at ambient temperature and pressure. Cleaning compositions having a VOC content between about 5 to 30 weight percent help reduce the need to hand clean the blanket. As a result, the overall amount of VOC exposure can be reduced. In one embodiment, the VOC content in the cleaning composition is between 10 and 30 percent by weight, preferably between 15 to 30 percent by weight, and more preferably between 20 and 30 percent by weight.

There are a wide variety of different cleaning compositions that can be used in the practice of the invention. In some embodiments, the cleaning composition comprises a combination of compounds that each individually may have high or low volatility. For example, in one embodiment, the cleaning composition may comprise a combination of compounds wherein one or more of the compounds has a VOC content greater than 30 weight percent, and one or more other compounds has a VOC content below 30 weight percent. In one embodiment, the cleaning composition has a flash point above 130° C. In some embodiments, it may be desirable that the cleaning composition have a VOC content below 30 weight percent because the impregnated roll may be exposed to the atmosphere for up to 30 days after it has been removed from the sealed wrapper. In addition, a very high surface area of the cleaning composition is exposed to the atmosphere due to the high surface area of the nonwoven fabric. The inclusion of low volatility solvents may help reduce evaporation of the solvent from the cleaning cloth.

The amount of cleaning composition present in the cleaning material is typically from about 20 to 200 gsm. Less cleaning composition, typically from about 20 to 100 gsm, is required on sheet fed presses that run at speeds up to 20,000 impression cylinder revolutions per hour. More cleaning composition, typically from about 80 to 200 gsm, is required on web fed presses that run at speeds exceeding 20,000 impression cylinder revolutions per hour.

Useful solvents that can be used in the cleaning composition include petroleum solvents including petroleum and water mixtures, having a VOC content between about 7 and 99 weight percent; blends of petroleum and esters, such as vegetable esters, having a VOC content from about 2 to 65 weight percent; vegetable esters includes blends with other esters and/or glycol ethers, having a VOC content from about 12 to 30 weight percent; blends of vegetable esters and water having a VOC content from about 2 to 10 weight percent; terpenes having VOC content between 10 and 30 weight percent, and combinations thereof.

In one embodiment, the cleaning composition comprises a combination of solvents having both high VOC content and low VOC content. In some embodiments, the cleaning composition comprises a blend of esters. Esters are particularly useful as organic solvents because they are typically biodegradable and many exhibit low vapor pressure. Suitable esters include, without limitation, both monobasic and dibasic esters having flash points that are about 130° C. or greater.

Particularly suitable esters are branched chain monobasic and dibasic esters that contain 2-ethyl hexanoate because they provide exceptional cleaning power. These include, without limitation, di(propylene glycol) di-2-ethylhexanoate, di (ethylene glycol) di-2-ethylhexanoate, neopentylglycol di-2-ethylhexanoate, 1,6-hexanediol di-2-ethylhexanoate (1:1), di-2-ethylhexyl adipate, octyl/decyl 2-ethylhexanoate. An exemplary cleaning composition includes octyl/decyl 2-ethylhexanoate. The amount of branched chain monobasic and dibasic esters that contain 2-ethyl hexanoate in the composition can be from about 0 to 100 percent by weight. An additional novel feature of these esters is that though exhibiting strong ink solvency, they have minimal interaction with the polymeric blanket substrates used for lithographic printing. This minimal interaction with polymeric substrates allows for efficient cleaning of the blanket without surface deterioration after repeated wiping cycles.

Isobutyl stearate is an excellent additive when in combination with branched chain monobasic and/or dibasic esters that contain 2-ethyl hexanoate. Isobutyl stearate is a common, low cost fluid with exceptional lubricity. Lubricity is helpful in reducing abrasion between the nonwoven fabric and the blanket. Isobutyl stearate cannot be used alone because of its low cleaning power. The amount of isobutyl stearate in the composition can be from about 0 to 50 percent by weight.

Other solvents can be used in cleaning composition including, without limitation, fatty acid derivatives, esters, methyl esters, ethers, glycols including ethylene and propylene glycol ethers, aromatic hydrocarbons, branched or unbranched aliphatic hydrocarbons, and combinations and blends thereof. Preferred solvents have a flashpoint above 130° C. so that they evaporate slowly and are not classified as a flammable liquid.

In one embodiment, the cleaning composition comprises one or more tall oil fatty acid esters that are blended with one or more organic solvents. Suitable tall oil fatty acid esters may comprise a mixture of alkyl esters, such as C₁ alkyl or methyl esters, of aliphatic tall oil fatty acids. Preferably the tall oil fatty acid esters comprise a mixture of C₁₈ aliphatic carboxylic tall oil fatty acids, saturated or unsaturated. A preferred composition of the tall oily fatty acid ester according to the invention comprises C₁₈ oleic acid and C₁₈ linoleic acid, other C₁₈ fatty acids, rosin acids, other fatty acids, and unsaponifiables. Suitable organic hydrocarbons may include aliphatic hydrocarbons, aromatic hydrocarbons, oxygenated solvents or terpene hydrocarbons, and mixtures thereof. In one preferred embodiment, the cleaning composition comprises a combination of organic hydrocarbons and tall oil fatty acids having a VOC content of about 29.7%.

The cleaning composition can also contain surfactants. The addition of a surfactant will help emulsify water that may be present on the presses. Water may be sprayed on the blanket to assist in removing any dirt or paper dust that may have accumulated. The amount of surfactant present in the solvent composition is typically from about 0 to 40% by weight. A somewhat more typical range is from about 5 to 15% by weight. The surfactant can also help remove ink residue by suspending it in water that can be removed from the surface. Additionally, the surfactants can act as an emulsifier between the aqueous, acidic or alkaline phase and the hydrocarbon phase. It is believed that the emulsion drops help loosen the printing ink and suspend it in the aqueous phase and support the surfactant molecules in stabilizing the emulsion while also stabilizing any droplets containing printing ink. Typically, the surfactant can be non-ionic, anionic, or cationic. An exemplary surfactant suitable for use in the present invention is Ethox 2680, which is an alkyl, polyoxyalkylene glycol ether.

One exemplary cleaning composition has a VOC content between about 20 and 30 weight percent and has a formulation containing about 60 to 90 weight percent octyl/decyl 2-ethylhexanoate and about 10 to 40 weight percent isobutyl stearate. In another embodiment, the cleaning composition comprises about 75 percent by weight octyl/decyl 2-ethylhexanoate, about 20 percent by weight isobutyl stearate, and about 5 percent by weight alkyl, polyoxyalkylene glycol ether surfactant. In this embodiment, the cleaning composition may have a VOC content that is about 25.5 weight percent.

Suitable cleaning fabrics can be made from a wide variety of different materials, and should have good strength and abrasion resistance. For example, the fabric can be made of paper, cloth, film, a mixture of wood pulp and polymeric materials such as polyester. The fabric can be a cloth that is prepared from woven or nonwoven cloth fabric that is comprised of synthetic or natural fibers or mixtures thereof. Exemplary synthetic fibers include, without limitation, nylon fibers, rayon fibers, polyester fibers, acrylic fibers, and the like. Exemplary natural fibers include, without limitation, cotton, wood pulp, hemp, wool, and the like.

A particularly useful cleaning fabric is comprised of a nonwoven fabric. A wide variety of different nonwovens can be used in the invention including, but not limited to, melt-blown nonwovens, spunbonded nonwovens, spun-laced nonwovens, air-laid nonwovens, and wet-laid nonwovens. The fibers/filaments are typically bonded together using chemical bonding, thermal bonding, or mechanical bonding. Thermal bonding processes include hot calendering, belt calendering, oven bonding, ultrasonic bonding, radiant heat bonding, and the like.

The spunbond nonwovens used in the present invention are made from continuous polymeric filaments that are thermally bonded together. Generally, spunbond nonwoven fabrics are prepared by extruding a thermoplastic polymer through a large number of fine spinneret orifices to form a multiplicity of continuous filaments, and the filaments of molten polymer are solidified and then drawn or attenuated, typically by high velocity air, and then randomly deposited on a collection surface. The filaments are then bonded to give the web coherency and strength. Area bonding and point bonding are two common techniques for bonding the web. Area bonding typically involves passing the web through a heated calender composed of two smooth steel rollers or passing heated steam, air or other gas through the web to cause the filaments to become softened and fuse to one another. Point bonding consists of using a heated calender nip to produce numerous discrete bond sites. The point bonding calender nip is comprised of two nip rolls, wherein at least one of the rolls has a surface with a pattern of protrusions. Typically, one of the heated rolls is a patterned roll and the cooperating roll has a smooth surface. As the web moves through the calender roll, the individual filaments are thermally bonded together at discrete locations or bond sites where the filaments contact the protrusions of the patterned roll. Preferably, the calender rolls are engraved with a pattern that produces point bonds over about 10 to 40 percent of the area of web surface, and more preferably about 20 to 30 percent.

For the present invention, thermal point bonding either with heat and pressure or by ultrasonics is the preferred bonding process because it coheres the filaments in small, discrete, and closely spaced areas of the web to produce a fabric that is quite strong and abrasion resistant. Point bonding imparts considerable strength to the fabric while retaining the integrity of the fibrous structure on both surfaces. In contrast, other bonding methods that are used to achieve high strength fabrics, such as area bonding, can result in glazing the surface of the fibers. As a result, the fibers can lose much of their fibrous nature and become “film-like.” This is usually an undesirable result because a cleaning cloth that is film-like will not typically clean as well as a fibrous cleaning cloth. On the other hand, if the thermally bonded nonwoven is too lightly bonded, the fibers near the surface might maintain their fibrous nature, and as a result, the abrasion resistance of the fabric could be compromised. The fibrous surface of the highly abrasion resistant point bonded fabric contributes to the ability of the fabric to remove ink and debris from the surfaces of the printing press undergoing cleaning. Additionally, patterned point bonding creates a fabric structure having a large number of “pockets” of relatively uncompacted filaments located between the more compacted and densified point bond sites. This structure enhances the ability of the fabric to hold and retain cleaning solvent during storage of the cleaning material prior to use, and to release the solvent onto the surfaces of the printing press during the cleaning operation. As a result, cleaning materials that are prepared in accordance with the invention are adeptly suited for removing ink and other residues from printing machinery.

Spunbonded nonwoven fabrics can be prepared from a variety of different thermoplastic polymers that are capable of being melt spun to form filaments. Examples of polymers that can be used to form the spunbonded nonwoven fabric include, without limitation, polyester, polyamide, polyolefins such as polypropylene, polyethylene, and olefin copolymers, or other thermoplastic polymers, copolymers and blends. These polymers may also be used in any combination or shape to from bicomponent or tricomponent filaments.

A particularly useful spunbond nonwoven fabric is comprised of polyester filaments, and more particularly is formed from polyester homopolymer filaments. A variety of additives can be used with the hompolymer including, but not limited to, optical brighteners, delusterants, opacifiers, colorants, antistats, and other common melt additives. A fibrous binder may also be included within the spunbond nonwoven fabric during the manufacturing process as continuous binder filaments in an amount effective to induce an adequate level of bonding. The binder is typically present in an amount ranging from about 2 to 20 weight percent, such as an amount of about 10 weight percent. The binder filaments are generally formed from a polymer composition exhibiting a melting or softening temperature at least about 10° C. lower than the homopolymer continuous filaments. Exemplary binder filaments may be formed from one or more lower melting polymers or copolymers, such as polyester copolymers. In one advantageous embodiment of the invention, the spunbond layer is produced by extruding polyester homopolymer matrix filaments (polyethylene terephthalate) interspersed with binder filaments formed from a lower melting polyester copolymer, such as polyethylene isophthalate. Typically, the homopolymer filaments constitute the matrix fiber and the copolymer filaments have a lower melting point and constitute a binder filament. Generally, as the web passes through the calender rolls, discrete point bonds are formed where the patterned roller contacts the individual filaments. The portions of the binder filaments that contact the heated protrusions on the calender roll are melted or rendered tacky while in contact with the heat calender roll, and as a result, the binder and matrix fibers are bonded to together to form a strong coherent fabric.

Suitable spunbond nonwoven fabrics should have a machine direction tensile strength typically of about 11,000 grams per inch and at least 5,000 grams per inch. The spunbonded nonwoven fabrics should also typically have a basis weight of from 40 to 125 gsm, and more desirably from about 60 to 90 gsm. The fabric typically has a machine direction elongation from about 19 to 49 percent, and somewhat more typically about 34 percent. The fabric typically has a Frasier porosity of at least 100 cubic feet of air per minute per square foot of fabric at a pressure differential of 0.5 inches of water.

Typically, the wrapper or container in which the cleaning material is packaged is impermeable to fluids and substantially impermeable to vapors. The wrapper and container can be made from a variety of different materials such as a film made from thermoplastic resin. The cleaning cloth is typically stored in the sealed wrapper or container until it is needed. At the appropriate time, the cleaning cloth can be removed from the wrapper and used to clean a printing press cylinder or blanket.

### EXAMPLES

The following example is provided for illustrative purposes only and should not be construed as limiting the invention.

In practice, cleaning materials having a VOC content less than about 1 weight percent do not adequately clean the blanket cylinders. As a result, press operators frequently have to hand wash the blankets with cleaning solution having a high VOC content, sometimes on the order of 75 to 100 weight percent VOC. As a result, the overall VOC exposure is greatly increased.

In the following example, the VOC exposure of a cleaning material impregnated with a low content VOC cleaning composition (less than 1 weight percent is compared to the VOC exposure of a cleaning material having a VOC content of about 25 weight percent.

| | | 75 percent by |
|---|---|---|
| | | weight octyl/decyl |
| | | 2-ethylhexanoate, |
| | | 20 percent by weight |
| | | isobutyl stearate, |
| | Competitor's product | 5 percent by weight |
| | having a VOC | alkyl polyoxyalkylene |
| | content of less than 1 | glycol ether |
| | weight percent. | surfactant. |
| VOC content of | Less than 1 weight | 25.5 weight percent |
| Cleaning composition¹ | percent | |
| Estimated VOC | 0.03 lbs | 0.7 lbs. |
| exposure from use of | | |
| fabric impregnated with | | |
| cleaning composition | | |
| for 40″ wide press² | | |
| Estimated VOC | 1.5 lbs | — |
| exposure from | | |
| +UZ,25/29 Hand Wash³ | | |
| Total VOC exposure | 1.8 lbs | 0.7 lbs |

¹Measured according to EPA TEST METHOD 24.
²Based on fabric cleaning of 4 colored stations (8 blankets for one day).
³Based on one additional hand washing per day of 4 colored stations (8 blankets) with 8 ounces/station and a cleaning composition having a VOC content of 75 weight percent.

Although it would be expected that a cleaning material having a VOC content up to 30 weight percent would result in a greater total VOC exposure, the above example demonstrates that the total amount of VOC exposure can be reduced in comparison to cleaning materials having a VOC content of about 1 weight percent or less. Thus, a VOC content between 5 and 30 weight percent can actually reduce the total amount of VOC that is needed to clean the printing blanket.

Many modifications and other embodiments of the invention set forth herein will come to mind to one skilled in the art to which the invention pertains having the benefit of the teachings presented in the foregoing descriptions and the associated drawing. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A cleaning material for use in an automated blanket cleaning system of a lithographic printing machine, said cleaning material comprising a nonwoven fabric wound into the form of a roll, and a cleaning composition impregnating the roll of fabric, said cleaning composition having a VOC content that is between 5 and 30 weight percent.

2. The cleaning material of claim 1, wherein the fabric is comprised of nylon fibers, rayon fibers, polyester fibers, acrylic fibers, cotton fibers, wood pulp, hemp fibers, or wool, or blends thereof.

3. The cleaning material of claim 1, wherein the fabric is a spunbond nonwoven fabric that is comprised of polyester filaments.

4. The cleaning material of claim 1, wherein the cleaning composition is present in the fabric at from about 20 to 200 gsm.

5. The cleaning material of claim 1, wherein cleaning composition comprises a branched chain monobasic and/or dibasic esters containing 2-ethyl hexanoate.

6. The cleaning material of claim 1, wherein the cleaning composition comprises about 60 to 90 weight percent octyl/decyl 2-ethylhexanoate and about 10 to 40 weight percent isobutyl stearate.

7. The cleaning material of claim 1, wherein the cleaning composition has a VOC content ranging from about 20 to 30 weight percent.

8. A cleaning material for use in an automated blanket cleaning system of a lithographic printing machine, said cleaning material comprising a spunbond nonwoven fabric formed of substantially continuous thermoplastic polymeric filaments bonded to one another to impart strength and abrasion resistance to the fabric, the spunbond nonwoven fabric having a machine direction tensile strength of at least 5,000 grams per inch and basis weight of from 40 to 125 gsm, and the fabric being wound into the form of a roll, and a cleaning composition impregnating the roll of spunbond nonwoven fabric, said cleaning composition having a VOC content from about 5 to 30 weight percent, based on the total weight of the cleaning composition.

9. The cleaning material of claim 8, wherein the spunbond nonwoven fabric is a thermally point bonded nonwoven fabric.

10. The cleaning material of claim 8, wherein the filaments of the spunbond nonwoven fabric are polyester filaments.

11. The cleaning material of claim 8, wherein the cleaning composition comprises a branched chain monobasic and/or dibasic esters containing 2-ethyl hexanoate.

12. The cleaning composition according to claim 11 wherein the branched chain monobasic or dibasic esters containing 2-ethyl hexanoate is at least one member selected from the group consisting of di(propylene glycol) di-2-ethylhexanoate, di (ethylene glycol) di-2-ethylhexanoate, neopentylglycol di-2-ethylhexanoate, 1,6-hexanediol di-2-ethylhexanoate (1:1), di-2-ethylhexyl adipate, and octyl/decyl 2-ethylhexanoate.

13. The cleaning material of claim 8, wherein the nonwoven fabric has a Frasier porosity of at least 100 cubic feet of air per minute per square foot of fabric at a pressure differential of 0.5 inches of water.

14. The cleaning material of claim 8, additionally including a sealed wrapper surrounding the roll of spunbond nonwoven fabric.

15. A cleaning material for use in an automated blanket cleaning system of a lithographic printing machine, said cleaning material comprising a sealed package containing a spunbond nonwoven fabric formed of substantially continuous thermoplastic polymeric filaments and including a multiplicity of discrete thermal point bonds bonding the filaments to one another to impart strength and abrasion resistance to the fabric, the spunbond nonwoven fabric having a machine direction tensile strength of at least 5,000 grams per inch and basis weight of from 40 to 125 gsm, and a cleaning composition impregnating the roll of spunbond nonwoven fabric, said cleaning composition having a VOC content that is between 15 and 30 weight percent.

16. The cleaning material of claim 15, wherein the fabric has point bonds that cover about 10 to 40 percent of the area of the fabric surface.

17. The cleaning material of claim 15, wherein the fabric is comprised of polymeric filaments that are selected from the group consisting of polyester, polyamide, polypropylene, polyethylene, olefin copolymers, and blends thereof.

18. The cleaning material of claim 15, wherein the fabric is comprised of polyester homopolymer filaments.

19. The cleaning material of claim 15, wherein the nonwoven fabric has a basis weight of from 40 to 125 gsm, and cleaning composition is present in the nonwoven fabric at from about 20 to 200 gsm.

20. The cleaning material of claim 15, wherein the cleaning composition comprises an ester, a hydrocarbon solvent, and a surfactant.

21. The cleaning material of claim 15, wherein the cleaning composition includes branched chain monobasic and/or dibasic esters containing 2-ethyl hexanoate and a surfactant.

22. The cleaning material according to claim 15, wherein the amount of branched chain monobasic and/or dibasic esters containing 2-ethyl hexanoate is up to 100 weight percent; the amount of isobutyl stearate is from about 0 to 50 weight percent, and the amount of surfactant is from about 0 to 40 weight percent.
